(19) United States
(12) Patent Application Publication
(10) Pub. No.: US 2026/0094392 A1
(43) Pub. Date: Apr. 2, 2026

(54) System and Method for Presenting Real and Virtual Content

(71) Applicant: Apple Inc., Cupertino, CA (US)

(72) Inventors: Adrian P. Lindberg, Karlstad (SE); Eshan Verma, San Francisco, CA (US); Srinidhi Aravamudhan, San Jose, CA (US)

(21) Appl. No.: 19/331,916

(22) Filed: Sep. 17, 2025

Related U.S. Application Data
(60) Provisional application No. 63/700,499, filed on Sep. 27, 2024.

(51) Int. Cl. G06T 19/00; G06T 7/50; G06T 7/73

(52) U.S. Cl. CPC G06T 19/006; G06T 7/50; G06T 7/73; G06T 2207/30196; G06T 2219/024

(57) ABSTRACT

Generating a composite image includes obtaining, at a first device, location data from a second device, determining if the person is in front of virtual content presented by the first device based on the location data. When the person is in front of the virtual content, a set of pixels are identified in the pass-through image corresponding to the person. The pass-through image data is blended with the virtual content based on the set of pixels. The set of pixels are determined based on joint information for the person received from the second device. A geometry is determined based on the joint information and used to adjust a transparency of the corresponding portion of the pass-through image data.

### BACKGROUND

With the rise of extended reality technology, users are more frequently using devices with pass-through or see-through display, in which virtual objects are depicted in a same view as physical objects. For example, head-mounted devices (HMDs) may enable users to view and interact with virtual content that is presented in a view of the real world.

In some scenarios, multiple users may share the same physical environment, and may or may not view the same virtual content using their respective mixed reality devices. For example, two users may collaborate on a presentation that is displayed as virtual content in their view of a conference room. As another example, two users may be using HMDs independently of each other. One drawback occurs when users move around the physical environment. This may cause inconsistencies in the intended relative location of the person and the virtual content in the view of the real environment. Thus, what is needed is a technique to improve spatial awareness between real and virtual content in a mixed reality environment.

### BRIEF DESCRIPTION OF THE DRAWINGS

FIG. 1 shows a flow diagram of a composite image of virtual content and a person in front of the virtual content, in accordance with one or more embodiments.

FIG. 2 shows a system diagram of a technique for generating a view of a mixed reality environment based on data from a remote device, according to one or more embodiments.

FIG. 3 shows a flowchart of a technique for generating a composite image of a mixed reality environment based on location data received from a remote device, in accordance with some embodiments.

FIG. 4 shows a flowchart of a technique for determining a relative depth of person and virtual content in a scene, according to some embodiments.

FIGS. 5A-B show flowcharts of example techniques for generating a person mask from location data, in accordance with some embodiments.

FIG. 6 shows a flowchart of a technique for compositing a frame from virtual content and pass-through data, according to some embodiments.

FIG. 7 shows an example view of a composite frame with multiple people in a mixed reality environment, in accordance with one or more embodiments.

FIG. 8 shows, in block diagram form, a simplified system diagram according to one or more embodiments.

FIG. 9 shows, in block diagram form, a computer system in accordance with one or more embodiments.

### DETAILED DESCRIPTION

This disclosure relates generally to image processing. More particularly, but not by way of limitation, this disclosure also relates to techniques and systems for compositing a mixed reality scene composed of people and virtual content.

This disclosure pertains to systems, methods, and computer readable media to generate a composite image by blending pass-through camera data and virtual content in a manner which maintains relative positioning of people in the scene and the virtual content. In some embodiments, multiple users may be present in a physical environment. A user of a local device may view the physical environment through a mobile device such as a head mounted device. When the other users are tracking their own location information, a local device can obtain that location information to determine a relative position between the local user, other user, and virtual content.

If the other user is positioned between the user and the virtual content such that the virtual content would be obstructed, then nearby spatial person matting may be used to adjust the rendering of the pass through data and the virtual content so as to clarify the relative position of the other person and the virtual content. Nearby spatial person matting refers to the ability to segment a portion of pass-through camera data including another person in a scene, such that a portion of a resulting composited image using the pass-through camera data will be composited by adjusting the segmented portion.

According to some embodiments, people segmentation may be performed by performing pixelized segmentation on the pass-through camera data based on people detected in the scene. In some embodiments, particular information for the location of the user may be received, such as joint tracking data or the like. Joint tracking data may be used to identify a skeleton of the user, from which a geometry of the user can be inferred. In some embodiments, a local device may receive location information, such as the joint information. Alternatively, the local device may receive the location of the geometry of the other person from the remote device.

Techniques described herein provide a technical improvement to presentation of a mixed reality environment by providing for a relative position of people and virtual content and environment. In addition, the geometry of the people in the environment may be determined based on tracking data already being collected by a person's electronic device, such as for body tracking techniques. By using nearby spatial person matting, a portion of the pass-through camera data can be adjusted to provide an indication of their relative positioning the other person and virtual content in accordance with a viewpoint of the local device.

In the following description, for purposes of explanation, numerous specific details are set forth in order to provide a thorough understanding of the disclosed concepts. As part of this description, some of this disclosure's drawings represent structures and devices in block diagram form, in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood however that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, or to resort to the claims being necessary to determine such inventive subject matter. Reference in this disclosure to “one embodiment” or to “an embodiment” means that a particular feature, structure, or characteristic described in connection with the embodiment, is included in at least one embodiment of the disclosed subject matter, and multiple references to “one embodiment” or “an embodiment” should not be understood as necessarily all referring to the same embodiment.

It should be appreciated that in the development of any actual implementation (as in any development project), numerous decisions must be made to achieve the developers'specific goals (e.g., compliance with system and business-related constraints), and that these goals will vary from one implementation to another. It will also be appreciated that such development efforts might be complex and time consuming, but would nevertheless be a routine undertaking for those of ordinary skill in the art of image capture having the benefit of this disclosure.

For purposes of this disclosure, the term “camera system” refers to one or more lens assemblies along with the one or more sensor elements and other circuitry utilized to capture an image. For purposes of this disclosure, the “camera” may include more than one camera system, such as a stereo camera system, multi-camera system, or a camera system capable of sensing the depth of the captured scene.

For purposes of this disclosure, the term “mixed reality environment” refers to a view of an environment that includes virtual content and physical content, such as image data from a pass-through camera or some view of a physical environment.

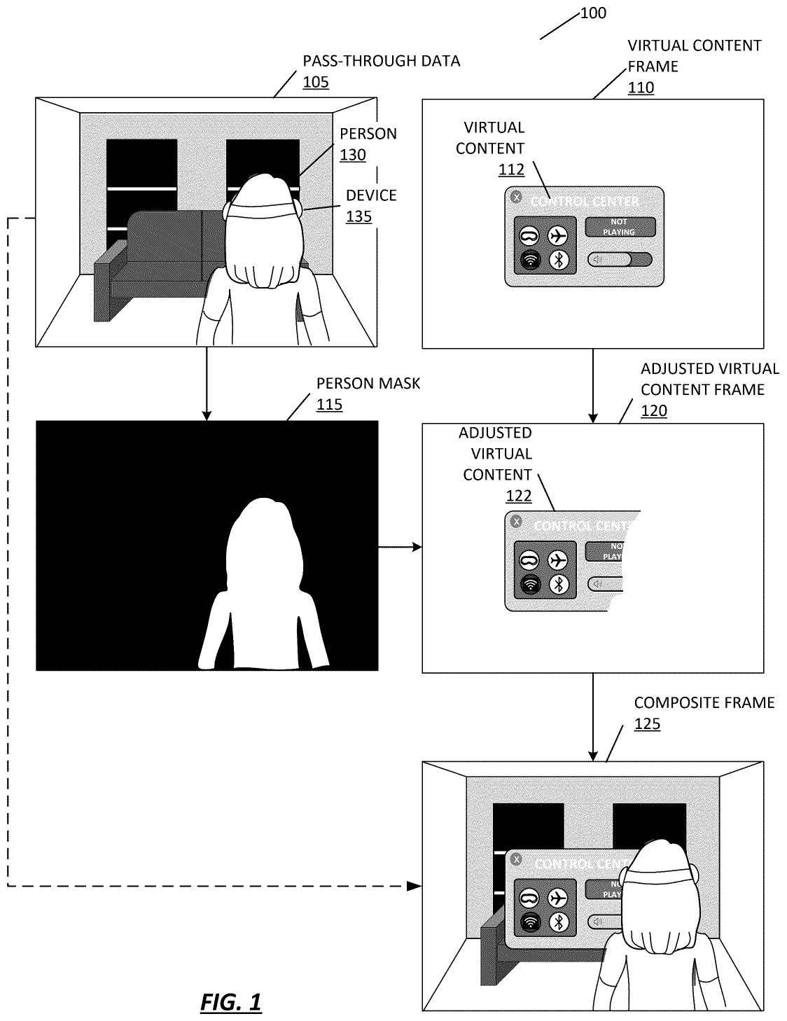

FIG. 1A illustrates an example of a flow diagram for generating a composite frame 125 according to some embodiments. Although the diagram is shown in a particular order, it should be understood that the flow may be performed in an alternate order. In addition, although the various functions may be described as being performed by particular components, it should be understood that in some embodiments the very features may be performed by alternative components.

Mixed reality often incorporates a view of a real environment with virtual content. As shown, the flow diagram 100 begins with pass-through data 105 and a virtual content frame 110. According to one or more embodiments, pass-through data 105 may be comprised of image data captured by a camera on a wearable device of a user. In this example, pass-through data 105 shows an image of an environment in which another person 130 is present. Thus, pass-through data 105 represents a view of the environment from the perspective of the local user. Virtual content frame 110 depicts an example of a frame of virtual content 112 indicating a location in a frame in which the virtual content 112 should be presented. Virtual content 112 may be content generated by the local device, received from another device, or the like. In some embodiments, virtual content 112 may be shared content to be presented by the local device as well as device 135 worn by person 130. This may occur, for example, if a local user and person 130 are participating in a copresence communication session.

The person 130 is also wearing a wearable device 135, which may be configured to determine location information for the person 130. For example, wearable device 135 may be configured to track location information for the person 130. A person mask 115 is generated from the pass-through data 105. The person mask 115 may be generated for a current frame from image data for that frame. Alternatively, the person mask may be generated based on image and/or location information from a prior frame in order to reduce latency in the system. In some of embodiments, the location information can be used to determine a relative location of the person compared to the local user. This may involve translating the location information received from the wearable device 135 into a common coordinate system with a local device. According to some embodiments, the location information may include joint location or other skeletal information for the person 130. The skeletal information can be used to infer a shape of the user. Accordingly, the person mask 115 can indicate a portion of the pass-through data 105 in which the shape of the user is located.

The flowchart proceeds to adjusted virtual content frame 120, which is generated based on the virtual content 112 and the person mask 115. According to some embodiments, the adjusted virtual content frame 120 may be adjusted to remove pixels that align with the person mask 115. The resulting adjusted virtual content 122 then represents a portion of the virtual content which is visible from the perspective of the local user.

The composite frame 125 is then generated by combining or blending the adjusted virtual content frame 120 with the pass-through data 105. The composite frame 125 can be displayed on the local device. In composite frame 125, the person 130 appears in front of the adjusted virtual content 122.

In an alternative embodiment, the person mask 115 may be used to adjust a transparency of the virtual content 112. For example, rather than removing pixels, the pixels that align with the person mask 115 may have a visual treatment applied to increase the transparency of the portion of the virtual content 112 based on the person mask 115. Then, when the pass-through data 105 is blended with the adjusted virtual content frame 120, the person 130 is visible through the corresponding portion of the virtual content such that the person 130 appears in front of the virtual content.

Although FIG. 1 shows the process performed with a single frame, the process could be performed on stereo frames. This means that the methods and devices described can handle multiple frames captured from slightly different angles to create a more immersive and realistic 3D experience for the user. Further, in some embodiments, the various processes may be performed on different frames within a series of frames. For example, the extraction of the person to generate the person mask may be performed on a different pass-through frame than the pass-through frame used to generate the composite frame.

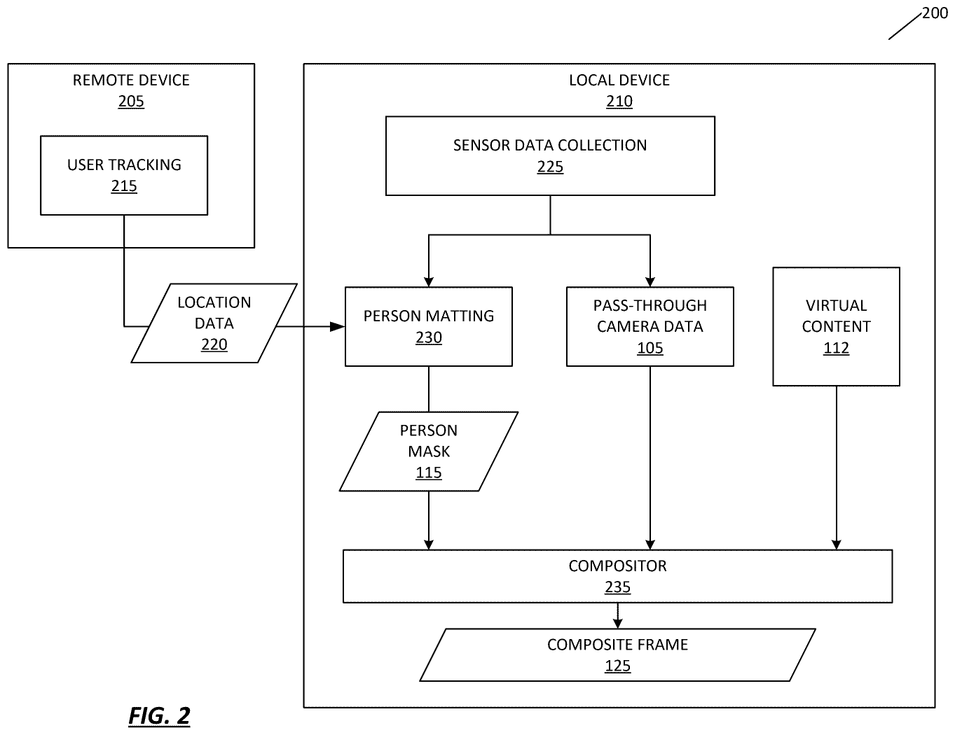

FIG. 2 illustrates an example flow diagram 200 in which embodiments described herein may be implemented. A local device 210 may be communicably coupled to a remote device 205. Each of remote device 205 and local device 210 may be electronic devices which support augmented reality environments. In some embodiments, a person using the remote device 205 and a person using the local device 210 may be collocated in a same physical environment, such that the users are visible to each other. Each of local device 210 and remote device 205 may be a wearable device, such as a head mounted device, through which a user is able to view the physical environment along with virtual content which may or may not be shared with other devices in a copresence communication session. Alternatively, remote device 205 may be an electronic device that is configured to provide location information from which a location of the user can be determined, and may or may not support mixed reality environments.

The flow diagram 200 includes remote device 205 performing user tracking functionality 215, to generate location data 220. The location data may be specific to a user of the remote device 205. For example, in some embodiments, the user tracking component 215 may be configured to performed joint or body tracking, such that the remote device 205 is able to predict location information for different parts of the user, from which an overall skeleton or pose can be determined. Alternatively, user tracking 215 may generate location information specific to the device itself. For example, location data such as GPS tracking or the like can be used to indicate a location of the remote device 205. The location data 220 is shared with a local device 210.

At the local device 210, sensor data collection 225 is performed. The sensor data collection 225 may include collection of data related to the user of the local device 210 and/or in which local device 210 is located. For example, local device 210 may include one or more pass-through cameras, from which image data of the physical device environment can be identified in the form of pass-through camera data 105. Sensor data collection 225 may additionally include sensor data collected for related to the user, such as a position or orientation of the user in the environment, gaze information, head position and orientation, or the like.

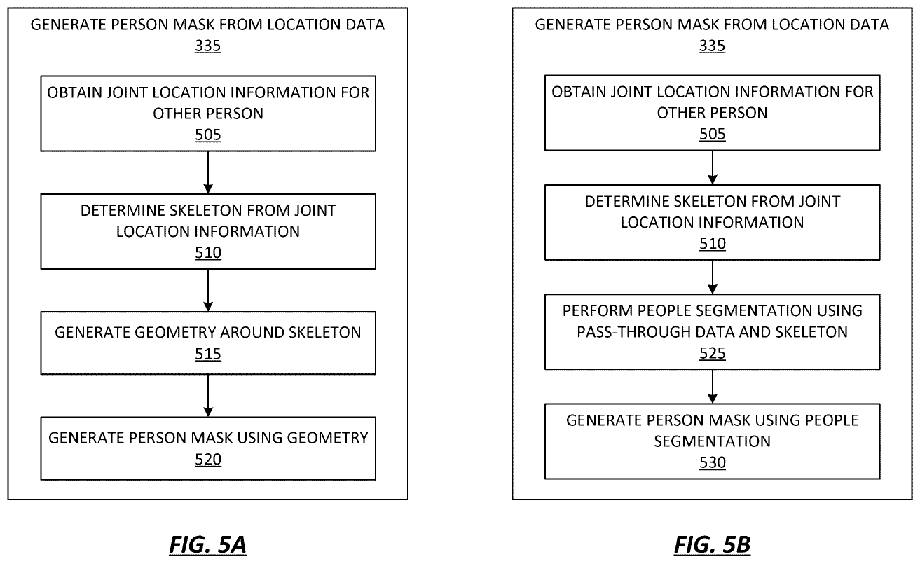

Person matting 230 may be performed based on the sensor data collection 225 and the location data 220. According to one or more embodiments, local device 210 may use the location data 220 for the user of remote device 205 to determine a portion of the pass-through camera data comprising the user. In doing so, person matting 230 may generate a person mask 115, indicative of a set of pixels or a region of an image in which the user is present. Person matting may be performed in a number of ways, as will be described in greater detail below with respect to FIGS. 5A-5B.

A compositor 235 of the local device 210 may be a hardware and/or software module configured to generate composite frame 125. In particular, compositor generates an image by blending together pass-through camera data 105 with virtual content 112 in accordance with the person mask 115. For example, compositor 235 may be configured to apply a visual treatment to a portion of pass-through camera data 105 and/or virtual content 112, such as increasing or decreasing an opacity, in accordance with the person mask 115.

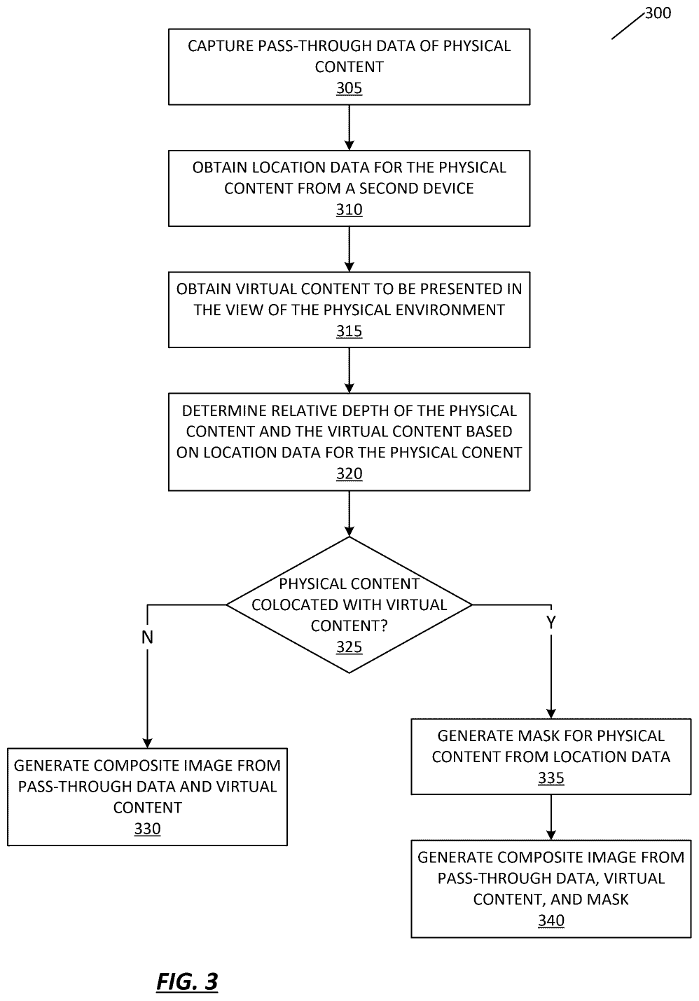

FIG. 3 illustrates a flowchart of a technique for generating a composite image of a mixed reality environment, according to one or more embodiments. In particular, FIG. 3 is directed to a technique to adjust virtual content based on a presence of physical content, such as other users in the view. For purposes of explanation, the processes described below are described as being performed by particular components. However, it should be understood that the various actions may be performed by alternate components. In addition, the various actions may be performed in a different order. Further, some actions may be performed simultaneously, and some may not be required, or others may be added.

The flowchart 300 begins at block 305, where pass-through image data of a physical environment is captured by a local device. The pass-through image data may capture a view of the physical environment that includes physical content, such as a physical object or another person (other than the user of the device capturing the pass-through data). The pass-through image data may be captured using one or more cameras on the local device. For example, if the local device is a wearable device or a head mounted device, the pass-through data may be captured by one or more outward facing scene cameras.

The flowchart 300 proceeds to block 310, where location data is obtained for the physical content present in the environment. According to some embodiment, the location data for the physical content may be received from a device being worn and/or used by the additional person. For example, the location information may include joint location data that indicates the position and orientation of various body joints of the additional person, such as the head, neck, shoulders, elbows, wrists, hips, knees, ankles, or the like. The location data can be obtained through various techniques, such as body tracking or the like. Additionally, or alternatively, the location data may be obtained from another source, for example from a common environment map shared between the local device and a device of the additional person.

At block 315, virtual content is obtained which is to be presented in the view of the physical environment. The virtual content may be shared virtual content with the additional person, or may be personal virtual content specific to the local user. to be presented in the view of the physical environment. The device can obtain virtual content to be presented in the view of the physical environment from a remote device, or may generate the virtual content locally. The virtual content can include any type of digital content, such as images, videos, text, graphics, animations, or any other suitable content. According to some embodiments, the virtual content may include metadata or other information indicative of a depth at which the virtual content is to be presented. Alternatively, a depth of the virtual content may be determined or adjusted by a user. For example, the user may place the virtual content in the scene, move the virtual content, resize the virtual content, or the like.

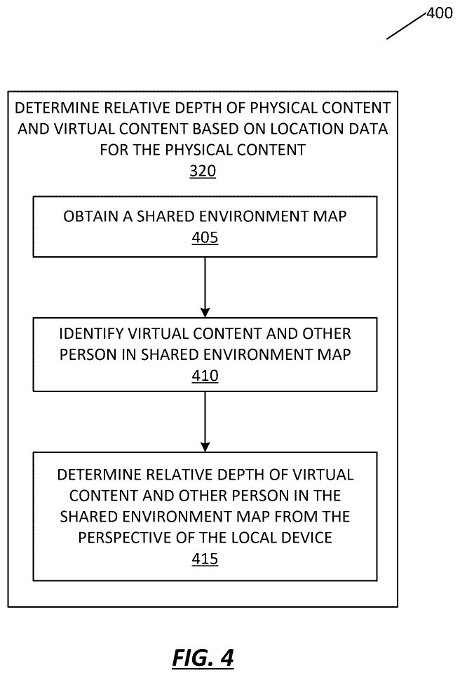

The flowchart proceeds to block 320, where the relative depth of the physical content and virtual content is determined based on location data for the additional person. The device can determine relative depth of the physical content and the virtual content based on the location data for the physical content. For example, the device can compare the depth values of the physical content and the virtual content in a shared environment map that represents the physical environment and the virtual content. As another example, the location information for the additional user and the location information for the virtual content may be determined in a common coordinate system and compared against each other. An example process for determining relative depth will be described in greater detail below with respect to FIG. 4.

At block 325, a determination is made as to whether the additional person and the virtual content are collocated. That is, a determination may be made as to whether the virtual content and additional person would be collocated in a frame capturing the mixed reality environment. In some embodiments, a determination is made as to whether the additional person would be obstructing the virtual content. If the additional person is not collocated with the virtual content, flowchart 300 concludes at block 330. At block 330, the composite image is generated from the pass-through data and the virtual content. In some embodiments, the composite image is generated without adjusting visual treatments of the virtual content and/or pass-through data due to overlap of the virtual content and additional person.

Returning to block 325, if a determination is made that additional person is collocated with the virtual content, then the flowchart 300 proceeds to block 335, and a mask is generated from the location data for the physical content. The mask may be a set of pixels which are identified as capturing the physical content. The local device can generate a mask that segments the physical content from the pass-through image data based on the location data received from the remote device. That is, rather than simply using the image data to identify the portion of the image that includes the physical content in the pass-through frame and segment the physical content from the frame, embodiments described herein additionally use the location information received from the device to determine the portion of the frame that includes the physical content. Various techniques can be used to generate the mask, as will be described in greater detail below with respect to FIGS. 5A-5B.

The flowchart concludes at block 340, where the composite image is generated from the pass-through data, virtual content, and person mask. In some embodiments, the person mask is used to adjust an opacity of a corresponding portion of the pass-through image data and/or virtual content. Generate composite image from pass-through image data, virtual content, and person mask. The local device can blend the pass-through image data and the virtual content based on the person mask such that the portion of the virtual content that corresponds to the pixels of the person mask can be made less opaque such that the other person is visible, or “shines through” the virtual content.

FIG. 4 shows a flowchart of a technique for determining a relative depth of person and virtual content in a scene, according to some embodiments. In particular, FIG. 4 is directed to a technique to determine whether a person is located such that virtual content would be obstructed from the perspective of the local device, for example from block 320 of FIG. 3. For purposes of explanation, the processes described below are described as being performed by particular components. However, it should be understood that the various actions may be performed by alternate components. In addition, the various actions may be performed in a different order. Further, some actions may be performed simultaneously, and some may not be required, or others may be added.

The flowchart 400 begins at block 405, where a shared environment map is obtained. The shared environment map may represent location information for various components among the physical environment and the virtual content. According to one or more embodiments, when two users are in a common mixed reality communication session, a shared environment map may be used to track location information for each user and other virtual and/or physical components in the environment. In doing so, the shared environment map can provide a mechanism for translating relative positioning between different users in the session and common virtual content by providing a common coordinate system. The shared environment map can track location information for devices in the environment, such as the local device, the device worn or used by the other user, and the like. In some embodiments, the shared environment map may be initialized by a synchronization process in which keyframes or other data is obtained from other users to determine a common mapping of components within the environment. The shared environment map may then remain synchronized among devices and/or objects in the mixed reality environment. The flowchart 400 proceeds to block 410, where the virtual content and the additional person are identified in shared environment map.

The flowchart 400 concludes at block 415, where the relative depth of the virtual content and the additional person are determined from the perspective of the device. For example, the device can compare the location information of the additional person to determine a depth of the additional person from the perspective of the local device. The depth may be a representative depth value for the person based on the location data. Similarly, the local device can compare the location information of the virtual content to a perspective of the local device to determine a depth of the virtual content. The comparison can indicate whether the other person should be in front of or behind the virtual content.

FIGS. 5A-B show flowcharts of alternate example techniques for generating a person mask from location data, in accordance with some embodiments. In particular, FIGS. 5A-5B are directed to example techniques to identifying a geometry or a set of pixels that includes the person, for example from block 335 of FIG. 3. For purposes of explanation, the processes described below are described as being performed by particular components. However, it should be understood that the various actions may be performed by alternate components. In addition, the various actions may be performed in a different order. Further, some actions may be performed simultaneously, and some may not be required, or others may be added.

Turning to FIG. 5A, the first technique is presented for identifying a geometry or a set of pixels that includes the person, for example from block 335 of FIG. 3. The flowchart begins at block 505, where joint location information for additional person is obtained. The local device can obtain joint location information for the additional person from a second device that is worn or used by the additional person. The joint location information can indicate the position and orientation of various body joints of the additional person, such as the head, neck, shoulders, elbows, wrists, hips, knees, ankles, and the like. The joint location information can be obtained, for example, through a body tracking process performed on the device worn or used by the additional person.

The flowchart proceeds to block 510, where a skeleton is determined from the joint location information. The skeleton can include a set of bones that connect the joints of the additional person. The skeleton can indicate the shape and pose of the additional person. According to one or more embodiments, the skeleton can be generated from the joint location information at a local device, or can be generated at and provided from a remote device, such as the device used and/or worn by the additional person.

At block 515, a geometry is generated around the skeleton. The geometry can include a shape of a person in the frame determined from the skeleton information. In some embodiments, the geometry can be determined based on a pose of the user. In some embodiments, additional information may be used, such as personal information for the other person, semantic information from the pass-through camera data, and the like.

The flowchart concludes at block 520, where a person mask is generated using the geometry. The person mask can indicate which pixels in the pass-through image data belong to the additional person based on the geometry. The person mask may be a geometric shape surrounding the other person in the pass-through image frame. In addition, the location information can be used to determine a shape of the person mask (that is, to determine the shape of the portion of the frame that includes the other person). For example, the location information can be used to generate a person mask to match the pose of the other person. The person mask can indicate which pixels in the pass-through image data belong to the additional person. The person mask can then be used to generate a composite image, as described above with respect to block 340 of FIG. 3. In some embodiments, the person mask can be generated by applying a threshold or a confidence score to the determined geometry, for example on a per-pixel basis, a per-region basis, or the like.

Turning to FIG. 5B, a second technique is presented for identifying a geometry or a set of pixels that includes the person, for example from block 335 of FIG. 3. As described above with respect to FIG. 5A, generating the person mask may include, at block 505, obtaining joint location information for additional person. The technique also includes, at block 510, determining a skeleton from the joint location information.

The flowchart continues at block 525, where people segmentation is performed using the pass-through image data and skeleton. People segmentation can include a process of identifying and separating the pixels in the pass-through image data that belong to the additional person from the pixels that belong to the background or other objects. The people segmentation can be performed using various techniques, such as a neural network model, a machine learning model, or any other suitable technique. For example, the image data and the skeleton (or joint location or depth relative to the passthrough camera position in a coordinate system shared between participating devices) may be fed into a network trained to predict a geometry around the person to which the skeleton belongs in the pass-through image data or, alternatively, predict which pixels correspond to a person.

Persons of ordinary skill in the art will appreciate that the pixel classification process or geometry determination can include any suitable machine learning models that are well-known or widely available such as regression techniques, classification techniques, neural networks, and deep learning networks. For instance, the process can include neural networks such as Artificial Neural Network (ANN), Convolutional Neural Network (CNN), Recurrent Neural Network (RNN), Adversarial Network (GAN), Reinforcement Learning Model (RLM), Encoder/Decoder Networks, and/or Transformer-Based Models (e.g., Bidirectional Encoder Representations from Transformers (BERT). Additionally, or alternatively, persons of ordinary skill in the art will appreciate that the process can be any suitable non-learning processes such as rule-based systems, heuristics, decision trees, knowledge-based systems, statistical or stochastic systems, and expert systems.

In instances where the pixel classification process or geometry determination uses a machine-learning based model, a corresponding model can be trained to classify pixels in an image as belonging to a physical object, and predicting pixels that comprise a geometry of the physical object using one or more well-known or widely available training techniques such as supervised learning, semi-supervised learning, unsupervised learning, and/or reinforcement learning techniques. The training data can include pre-marked image data having particular objects, such as pre-marked images having predefined physical objects such as people or the like.

The flowchart concludes at block 530, where the person mask is generated using people segmentation. The person mask can indicate which pixels in the pass-through image data belong to the additional person. In some embodiments, the person mask can be generated by applying a threshold or a confidence score to the output of the people segmentation, for example on a per-pixel basis, a per-region basis, or the like. The person mask can then be used to generate a composite image, as described above with respect to block 240 of FIG. 3.

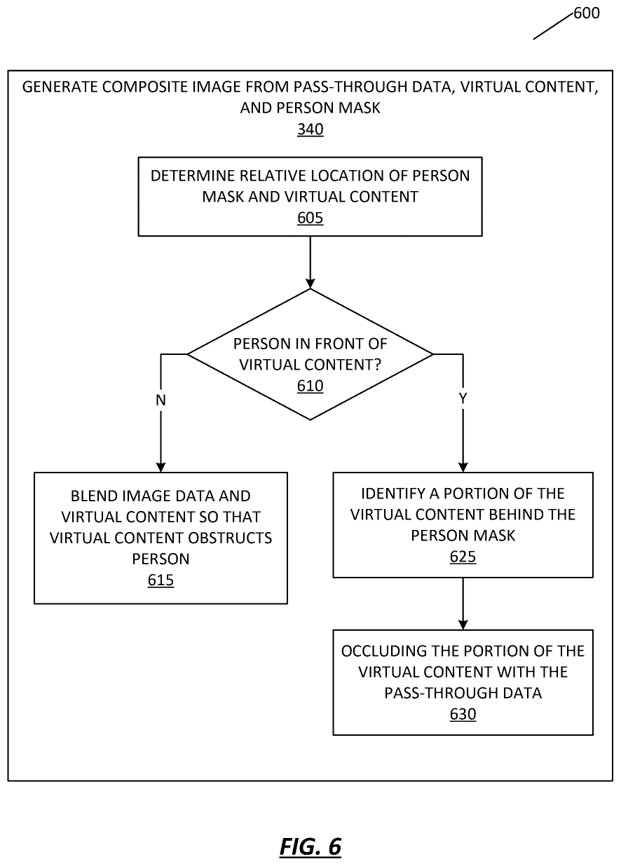

FIG. 6 shows a flowchart of a technique for compositing a frame from virtual content and pass-through data, according to some embodiments. In particular, FIG. 6 is directed to a technique to determine whether a person is located such that virtual content would be obstructed from the perspective of the local device, for example from block 340 of FIG. 3. For purposes of explanation, the processes described below are described as being performed by particular components. However, it should be understood that the various actions may be performed by alternate components. In addition, the various actions may be performed in a different order. Further, some actions may be performed simultaneously, and some may not be required, or others may be added.

The flowchart begins at block 605 where a relative location of the additional person and the virtual content is determined. For example, the device can compare a depth of the person and the depth of the virtual content from the perspective of the local device. The relative depth may be determined from location information provided by the additional person's device and/or the virtual content. Additionally, or alternatively, the relative depth may be determined based on a relative location of the components from a shared environment map for the mixed reality environment.

The flowchart 600 proceeds to block 610, where a determination is made as to whether the additional person is in front of the virtual content from the perspective of the local device. If the person is not in front of the virtual content, then the flowchart proceeds to block 615, and the pass-through image data and the virtual content are blended to generate a composite image without any adjustment to the content based on a person mask corresponding to the additional person.

Returning to block 610, if a determination is made that the person is in front of the virtual content, then the flowchart 600 proceeds to block 625. At block 625, a portion of the virtual content behind the person mask is identified. The local device can identify the portion of the virtual content that is occluded by the person mask by comparing the person mask to the virtual content. For example, a set of pixels or a region of the virtual content can be identified.

The flowchart 600 concludes at block 630, where at least a portion of the virtual content is occluded. According to one or more embodiments, the virtual content image data may be removed during the blending at the region identified by the person mask such that the camera image data presented at that region of the display is more prevalent than the virtual content. For example, an opacity of the virtual content may be reduced for a region that aligns with the person mask. As a result, the person in the environment appears in the mixed reality image to be in front of the virtual content from the perspective of a local user.

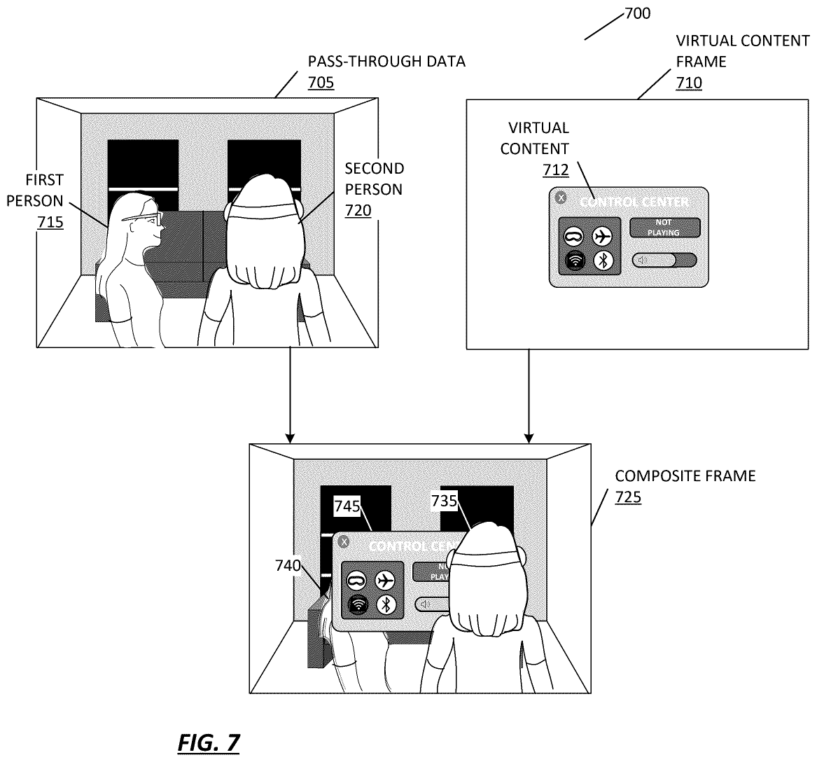

In some embodiments, the various processes described above may be performed for each person visible in the physical environment. Referring to FIG. 7, an example flow diagram of a technique for generating a composite frame with multiple people in a mixed reality environment is presented, in accordance with one or more embodiments. In the flow diagram 700, pass-through data 705 shows an example image frame having a first person 715 and a second person 720 visible to a local user of the local device. Thus, pass-through data 105 represents a view of the environment from the perspective of the local user.

For purposes of the example, virtual content frame 710 depicts an example of a frame of virtual content 712 indicating a location in a frame in which the virtual content 712 should be presented. Virtual content 712 may be content generated by the local device, received from another device, or the like. In some embodiments, virtual content 712 may be shared content to be presented by the local device as well as devices worn by person 715 and/or person 720. This may occur, for example, if a local user and first person 715 and/or second person 720 are participating in a copresence communication session.

In this example, when the composite frame 725 is generated, the portion of the composite frame 725 that includes the first person 740 appears behind the virtual content, whereas the portion of the composite frame 725 that includes the second person 735 appears in front of the frame. In some embodiments, the representation of virtual content 745 in the composite frame 725 may be adjusted so that the portion of the virtual content 712 that overlaps with a person mask for second person 720 is removed or becomes less opaque. This may occur, for example, if a determination is made that the relative depth of the first person 715 and the virtual content 712 indicates that the first person 715 is not in front of the virtual content 712, while a determination is made that the relative depth of the second person 720 and the virtual content 712 indicates that the second person 720 is in front of the virtual content 712.

In an alternative embodiment, the system may operate in scenarios where a person, such as second person 720, is present in the physical environment but is not participating in the communication session and, therefore, does not provide location or joint data from a remote device while the device of first person 715 does provide location data. In such cases, the local device may determine the depth of second person 720 independently, for example by employing person detection processes. For example, the local device may utilize image analysis methods, such as machine learning-based object detection or segmentation models, to identify the presence and outline of the second person 720, along with a depth of the person, within the pass-through camera data. The local device may estimate the depth of first person 720 relative to the virtual content by comparing the determined depth for the second person 720 with the depth of the virtual content 712. A person mask for the second person 720 may be generated therefrom, and can then be used to composite the mixed reality scene.

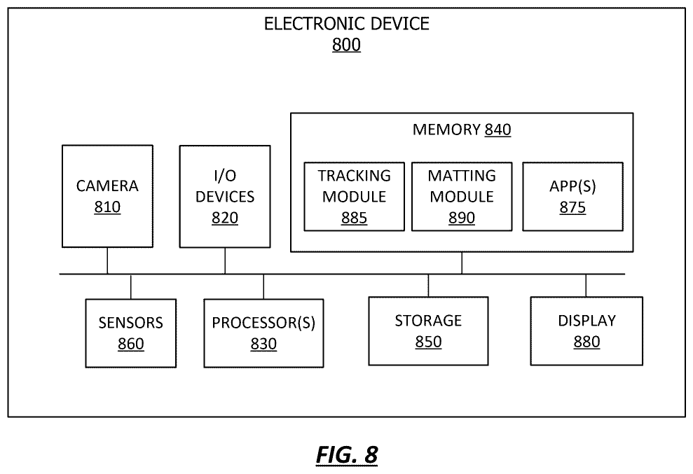

Referring to FIG. 8, a simplified block diagram of an electronic device 800 which may be utilized to generate and display mixed reality scenes. The system diagram includes electronic device 800 which may include various components. Electronic device 800 may be part of the multifunctional device, such as phone, tablet computer, personal digital assistant, portable music/video player, wearable device, base station, laptop computer, desktop computer, network device, or any other electronic device that has the ability to capture image data and present mixed reality content.

Electronic device 800 may include one or more processors 830, such as a central processing unit (CPU). Processors 830 may include a system-on-chip such as those found in mobile devices and include one or more dedicated graphics processing units (GPUs) or other graphics hardware. Further, processor(s) 830 may include multiple processors of the same or different type. Electronic device 800 may also include a memory 840. Memory 840 may include one or more different types of memory, which may be used for performing device functions in conjunction with processors 830. Memory 840 may store various programming modules for execution by processor(s) 820, including tracking module 885, matting module 890, and other various applications 875 which may produce virtual content. Electronic device 800 may also include storage 850. Storage 850 may include data utilized by the tracking module 885, matting module 890, and/or applications 875. For example, storage 850 may be configured to store user profile data, media content to be displayed as virtual content, and the like.

In some embodiments, the electronic device 800 may include other components utilized for vision-based tracking, such as one or more cameras 810 and/or other sensors, such as one or more depth sensors 860. In one or more embodiments, each of the one or more cameras 810 may be a traditional RGB camera, a depth camera, or the like. Further, cameras 810 may include a stereo or other multi camera system, a time-of-flight camera system, or the like which capture images from which depth information of the scene may be determined. Cameras 810 may include cameras incorporated into electronic device 800 capturing different regions. For example, cameras 810 may include one or more scene cameras and one or more user-facing cameras, such as eye tracking cameras or body tracking cameras.

In one or more embodiments, tracking module 885 may track user characteristics, such as joint locations for a local user, body tracking information, or the like. Tracking module 885 may also determine a location of the device and/or local user within an environment. Matting module 890 may be configured to determine person masks from image data captured by camera 810 and location information received from another device. Display 880 may include a pass-through or see-through display which may be configured to present composited images and may include a stereo display system.

Although electronic device 800 is depicted as comprising the numerous components described above, and one or more embodiments, the various components and functionality of the components may be distributed differently across one or more additional devices, for example across a network. In some embodiments, any combination of the data or applications may be partially or fully deployed on additional devices, such as network devices, network storage, and the like. Similarly, in some embodiments, the functionality of tracking module 885, matting module 890, and applications 875 may be partially or fully deployed on additional devices across a network.

Further, in one or more embodiments, electronic device 800 may be comprised of multiple devices in the form of an electronic system. Accordingly, although certain calls and transmissions are described herein with respect to the particular systems as depicted. In one or more embodiments, the various calls and transmissions may be differently directed based on the differently distributed functionality. Further, additional components may be used, or some combination of the functionality of any of the components may be combined.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include: head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

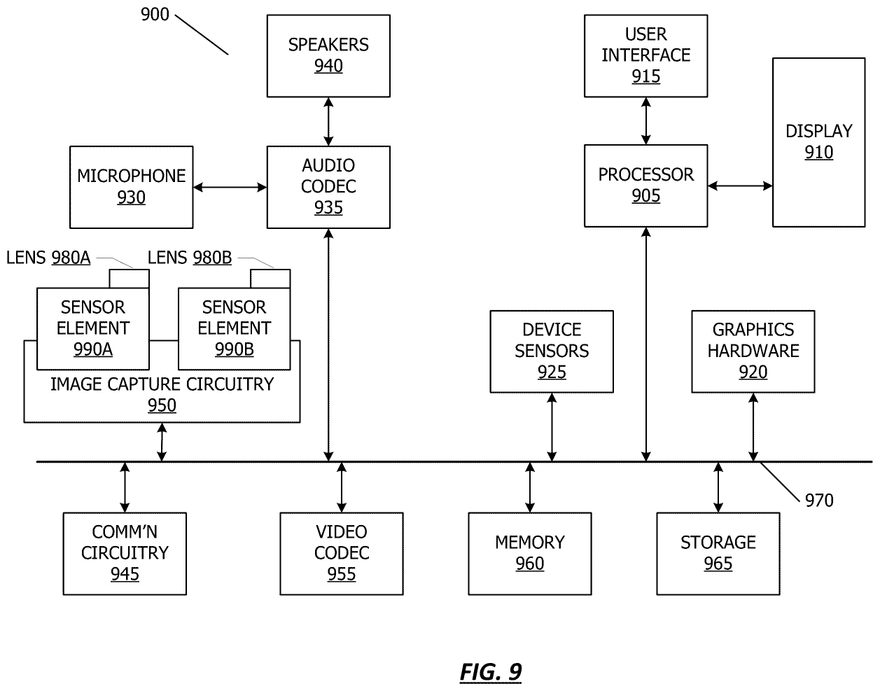

Referring now to FIG. 9, a simplified functional block diagram of illustrative multifunction electronic device 900 is shown according to one embodiment. Each of the electronic devices may be a multifunctional electronic device, or may have some or all of the described components of a multifunctional electronic device described herein. Multifunction electronic device 900 may include some combination of processor 905, display 910, user interface 915, graphics hardware 920, device sensors 925 (e.g., proximity sensor/ambient light sensor, accelerometer and/or gyroscope), microphone 930, audio codec 935, speaker(s) 940, communications circuitry 945, digital image capture circuitry 950 (e.g., including camera system), memory 960, storage device 965, and communications bus 970. Multifunction electronic device 900 may be, for example, a mobile telephone, personal music player, wearable device, tablet computer, and the like.

Processor 905 may execute instructions necessary to carry out or control the operation of many functions performed by device 900. Processor 905 may, for instance, drive display 910 and receive user input from user interface 915. User interface 915 may allow a user to interact with device 900. For example, user interface 915 can take a variety of forms, such as a button, keypad, dial, a click wheel, keyboard, display screen, touch screen, and the like. Processor 905 may also be a system-on-chip such as those found in mobile devices and include a dedicated graphics processing unit (GPU). Processor 905 may be based on reduced instruction-set computer (RISC) or complex instruction-set computer (CISC) architecture or any other suitable architecture and may include one or more processing cores. Graphics hardware 920 may be special purpose computational hardware for processing graphics and/or assisting processor 905 to process graphics information. In one embodiment, graphics hardware 920 may include a programmable GPU.

Image capture circuitry 950 may include one or more lens assemblies, such as 980A and 980B. The lens assemblies may have a combination of various characteristics, such as differing focal length and the like. For example, lens assembly 980A may have a short focal length relative to the focal length of lens assembly 980B. Each lens assembly may have a separate associated sensor element 990A and sensor element 990B. Alternatively, two or more lens assemblies may share a common sensor element. Image capture circuitry 950 may capture still images, video images, enhanced images, and the like. Output from image capture circuitry 950 may be processed, at least in part, by video codec(s) 955 and/or processor 905 and/or graphics hardware 920, and/or a dedicated image processing unit or pipeline incorporated within circuitry 945. Images so captured may be stored in memory 960 and/or storage 965.

Memory 960 may include one or more different types of media used by processor 905 and graphics hardware 920 to perform device functions. For example, memory 960 may include memory cache, read-only memory (ROM), and/or random-access memory (RAM). Storage 965 may store media (e.g., audio, image and video files), computer program instructions or software, preference information, device profile information, and any other suitable data. Storage 965 may include one more non-transitory computer-readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 960 and storage 965 may be used to tangibly retain computer program instructions or computer readable code organized into one or more modules and written in any desired computer programming language. When executed by, for example, processor 905 such computer program code may implement one or more of the methods described herein.

Some embodiments described herein can include use of learning and/or non-learning-based process(es). The use can include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in the pixel classification processes can be used to benefit users. For example, the data can be used to train models that can be deployed to improve performance, accuracy, and/or functionality of applications and/or services. Accordingly, the use of the data enables the pixel classification processes to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the pixel classification processes are also contemplated by the present disclosure.

The present disclosure contemplates that, in some embodiments, data used by pixel classification processes includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to, data used in association with [technology descriptor] processes, should attempt to comply with well-established privacy policies and/or privacy practices.

For example, such entities may implement and consistently follow policies and practices recognized as meeting or exceeding industry standards and regulatory requirements for developing and/or training [technology descriptor] processes. In doing so, attempts should be made to ensure all intellectual property rights and privacy considerations are maintained. Training should include practices safeguarding training data, such as personal information, through sufficient protection against misuse or exploitation. Such policies and practices should cover all stages of the [technology descriptor] processes development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy guidelines.

In some embodiments, [technology descriptor] processes may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for pixel classification processes may be kept strictly separated from platforms where the pixel classification processes are deployed and/or used to interact with users and/or process data. In such embodiments, data used for offline training of the pixel classification processes may be maintained in secured datastores with restricted access and/or not be retained beyond the duration necessary for training purposes. In some embodiments, the pixel classification processes may utilize a local memory cache to store data temporarily during a user session. The local memory cache may be used to improve performance of the pixel classification processes. However, to protect user privacy, data stored in the local memory cache may be erased after the user session is completed. Any temporary caches of data used for online learning or inference may be promptly erased after processing. All data collection, transfer, and/or storage shou

In some embodiments, as noted above, techniques such as federated learning, differential privacy, secure hardware components, homomorphic encryption, and/or multi-party computation among other techniques may be utilized to further protect personal information data during training and/or use of the pixel classification processes. The pixel classification processes should be monitored for changes in underlying data distribution such as concept drift or data skew that can degrade performance of the [technology descriptor] processes over time.

In some embodiments, the pixel classification processes are trained using a combination of offline and online training. Offline training can use curated datasets to establish baseline model performance, while online training can allow the pixel classification processes to continually adapt and/or improve. The present disclosure recognizes the importance of maintaining strict data governance practices throughout this process to ensure user privacy is protected.

In some embodiments, the [technology descriptor] processes may be designed with safeguards to maintain adherence to originally intended purposes, even as the [technology descriptor] processes adapt based on new data. Any significant changes in data collection and/or applications of pixel classification process use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the [technology descriptor] processes and/or for use as input during the inference stage of such systems. In yet another example, the present technology should be configured to allow users to be able to select to limit the length of time data is maintained or entirely prohibit the use of their data for use by the [technology descriptor] processes. In addition to providing “opt in” and “opt out” options, the present disclosure contemplates providing notifications relating to the access or use of personal information. For instance, a user can be notified when their data is being input into the pixel classification processes for training or inference purposes, and/or reminded when the pixel classification processes generate outputs or make decisions based on their data.

The present disclosure recognizes pixel classification processes should incorporate explicit restrictions and/or oversight to mitigate against risks that may be present even when such systems have been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to or failures to cite third-party products and/or services in the outputs should not be construed as endorsements or affiliations by the entities providing the pixel classification processes. Generated content can be filtered for potentially inappropriate or dangerous material prior to being presented to users, while human oversight and/or ability to override or correct erroneous or undesirable outputs can be maintained as a failsafe.

The present disclosure further contemplates that users of the pixel classification processes should refrain from using the services in any manner that infringes upon, misappropriates, or violates the rights of any party. Furthermore, the pixel classification processes should not be used for any unlawful or illegal activity, nor to develop any application or use case that would commit or facilitate the commission of a crime, or other tortious, unlawful, or illegal act including misinformation, disinformation, misrepresentations (e.g., deepfakes), deception, impersonation, and propaganda. The pixel classification processes should not violate, misappropriate, or infringe any copyrights, trademarks, rights of privacy and publicity, trade secrets, patents, or other proprietary or legal rights of any party, and appropriately attribute content as required. Further, the [technology descriptor] processes should not interfere with any security, digital signing, digital rights management, content protection, verification, or authentication mechanisms. The pixel classification processes should not misrepresent machine-generated outputs as being human-generated.

It is to be understood that the above description is intended to be illustrative, and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 1-7 or the arrangement of elements shown in FIGS. 8-9 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
obtaining, at a first device, location data from a second device, wherein the location data corresponds to a location of a user of the second device; and
in accordance with a determination that the user of the second device is in front of virtual content based on the location data from a perspective of the first device:
determining a set of pixels in pass-through image data comprising the user based on the location data, and
blending the pass-through image data with the virtual content by occluding at least a portion of the virtual content corresponding to the set of pixels.

2. The method of claim 1, wherein the location data comprises joint location data for the user of the second device.

3. The method of claim 2, wherein determining the set of pixels in the pass-through image data comprises:
determining a skeleton for the user of the second device based on the joint location data;
generating a geometry around the skeleton; and
identifying the set of pixels in the pass-through image data corresponding to the geometry.

4. The method of claim 1, wherein the set of pixels are determined in a first frame of the pass-through image data, and wherein blending the pass-through image data with the virtual content comprises blending the virtual content with a second frame of the pass-through image data.

5. The method of claim 1, further comprising:
determining a location of the virtual content from an environment map shared between the first device and the second device.

6. The method of claim 5, wherein the determination that the user of the second device is in front of the virtual content is based on the environment map.

7. The method of claim 5, wherein the determination that the user of the second device is in front of the virtual content is further based on a representative depth value for the user of the second device based on the location data.

8. A non-transitory computer readable medium comprising computer readable code executable by one or more processors to:
obtain, at a first device, location data from a second device, wherein the location data corresponds to a location of a user of the second device; and
in accordance with a determination that the user of the second device is in front of virtual content based on the location data from a perspective of the first device:
determine a set of pixels in pass-through image data comprising the user based on the location data, and
blend the pass-through image data with the virtual content by occluding at least a portion of the virtual content corresponding to the set of pixels.

9. The non-transitory computer readable medium of claim 8, wherein the location data comprises joint location data for the user of the second device.

10. The non-transitory computer readable medium of claim 9, wherein the computer readable code to determine the set of pixels in the pass-through image data comprises computer readable code to:
determine a skeleton for the user of the second device based on the joint location data;
generate a geometry around the skeleton; and
identify the set of pixels in the pass-through image data corresponding to the geometry.

11. The non-transitory computer readable medium of claim 8, wherein the set of pixels are determined in a first frame of the pass-through image data, and wherein blending the pass-through image data with the virtual content comprises blending the virtual content with a second frame of the pass-through image data.

12. The non-transitory computer readable medium of claim 8, further comprising computer readable code to:
determine a location of the virtual content from an environment map shared between the first device and the second device.

13. The non-transitory computer readable medium of claim 12, wherein the determination that the user of the second device is in front of the virtual content is based on the environment map.

14. The non-transitory computer readable medium of claim 12, wherein the determination that the user of the second device is in front of the virtual content is further based on a representative depth value for the user of the second device based on the location data.

15. A system comprising:
one or more processors; and
one or more non-transitory computer readable medium comprising computer readable code executable by the one or more processors to:
obtain, at a first device, location data from a second device, wherein the location data corresponds to a location of a user of the second device; and
in accordance with a determination that the user of the second device is in front of virtual content based on the location data from a perspective of the first device:
determine a set of pixels in pass-through image data comprising the user based on the location data, and
blend the pass-through image data with the virtual content by occluding at least a portion of the virtual content corresponding to the set of pixels.

16. The system of claim 15, wherein the location data comprises joint location data for the user of the second device.

17. The system of claim 16, wherein the computer readable code to determine the set of pixels in the pass-through image data comprises computer readable code to:
determine a skeleton for the user of the second device based on the joint location data;
generate a geometry around the skeleton; and
identify the set of pixels in the pass-through image data corresponding to the geometry.

18. The system of claim 15, wherein the set of pixels are determined in a first frame of the pass-through image data, and wherein blending the pass-through image data with the virtual content comprises blending the virtual content with a second frame of the pass-through image data.

19. The system of claim 15, further comprising computer readable code to:
determine a location of the virtual content from an environment map shared between the first device and the second device.

20. The system of claim 19, wherein the determination that the user of the second device is in front of the virtual content is based on the environment map.
